(19) United States
(12) Patent Application Publication
(10) Pub. No.: US 2008/0303663 A1
(43) Pub. Date: Dec. 11, 2008

(54) METHOD FOR VERIFYING THE INTEGRITY OF A CONTAINER

(75) Inventors: Terry SMITH, Sunnyvale, CA (US); Lionel Garin, Palo Alto, CA (US)

Correspondence Address: FOLEY AND LARDNER LLP;SUITE 500, 3000 K STREET NW, WASHINGTON, DC, 20007, US

(73) Assignee: NEMERIX SA

(21) Appl. No.: 11/760,533

(22) Filed: Jun. 8, 2007

(51) Int. Cl. G08B 13/00

(52) U.S. Cl. 340/550

(57) ABSTRACT

A container security device comprises a sensor and a local memory configured to store input from the sensor, wherein the device is configured to detect a breach of a container. A container security method comprises the steps of detecting a change in a measurement value inside a container, and indicating a breach if a change in measurement value exceeds a threshold. A method of determining if a container was breached comprises the steps of downloading a log of gathered information, and checking the gathered information for any abnormalities, wherein the gathered information includes at least one sensor measurement taken from the inside of a container. A device for maintaining security of a navigation receiver unit comprises an enclosure, comprising a sensor, a processor, a local memory configured to store input from the sensor, and a navigation receiver unit, wherein the device is configured to detect a breach of the enclosure.

### CROSS-REFERENCE TO RELATED APPLICATIONS

This application incorporates by reference the provisional application entitled “GNSS Positioning Using Pressure Sensors” filed Jun. 8, 2007, Application Ser. No. 60/942,920 (Attorney Docket No. 059472-0118).

### BACKGROUND OF THE INVENTION

The embodiments of the present invention relate generally to the verification of the integrity of a container, and especially a container in transit.

Each year, more than nine million freight containers arrive at U.S. ports, approximately 50 percent more than 2001 because of the proliferation of global trade and “just-in-time” manufacturing and retailing strategies. The increased threat of global terrorism has raised awareness that these containers are a vulnerable point in the supply chain.

Supply chain security is critically important to both vendors and customers and the well-being of the global economy. Assurance that the integrity of the contents of a container in transit can be verified is crucial to ensuring secure, efficient shipping. Security concerns exist concerning the inclusion of materials into cargo being shipped worldwide. Vendors and consumers also want guarantees that the containers in transit are the correct containers, and are in acceptable condition to be sold or used.

Existing container intrusion detection systems build upon mechanical devices such as locks and bolts to ensure that the contents of a container are not available. Security methods with these old-fashioned mechanical security systems are prevalent. Examples of such systems include tamper evident secure containers. These containers are encryption-enabled, such that the shipper can arm the container using a unique, encrypted code. The container is packed and sealed with a traditional bolt seal. As the container passes within range of the global wireless reader infrastructure, which is similar to common electronic toll collection systems, the container security device tells logistics and customs officials where the container is located, when it arrived, and if unauthorized personnel opened it en route.

As is evident, technologies that utilize these mechanical constraints have numerous limitations. They can be bypassed by puncturing the container, or deactivating the security device placed in or on the container. Further, since these security devices pass within range of global wireless reader infrastructure, a malignant entity need only remove the container from its route when the reader infrastructure is not able to detect the container as mentioned above. Thus, the whereabouts of that container becomes unknown, and the contents no longer remain secure. The contents of the container could be tampered with and then placed back in the shipping route. The existence and location of a breach would never be known. These existing security devices also fail to detect theft of a container. There is no indication, until a container does not arrive as scheduled within range of a global wireless reader infrastructure, that the container has been stolen or waylaid.

Another constraint placed upon such existing technologies is the inability to successfully be utilized on smaller containers. Depending upon the size of the container, the infrastructure that needs to be added to the container may make the utilization of current intrusion devices inapplicable. Placing locks or bolts on very small containers may not be physically conducive. The integrity of such mechanical constraints may also not be verifiable as failure-proof or tamper-resistant. Further, existing intrusion detection devices may not even be embeddable or attachable to smaller containers.

An integrity verification system is needed that overcomes these limitations of the existing technology.

### SUMMARY OF THE INVENTION

Certain embodiments of the present invention relate to container security mechanisms.

In a first embodiment, a container security device comprises a sensor and a local memory configured to store input from the sensor, wherein the device is configured to detect a breach of a container.

A second embodiment of the invention relates to a method of securing a container, comprising the steps of detecting a change in a measurement value inside a container, and indicating a breach if a change in measurement value exceeds a threshold.

A third embodiment of the invention relates to a method of determining if a container was breached, comprising the steps of downloading a log of gathered information, and checking the gathered information for any abnormalities, wherein the gathered information includes at least one sensor measurement taken from the inside of a container.

A fourth embodiment of the invention relates to a device for maintaining security of a navigation receiver unit, comprising an enclosure, comprising a sensor, a processor, a local memory configured to store input from the sensor, and a navigation receiver unit, wherein the device is configured to detect a breach of the enclosure.

### BRIEF DESCRIPTION OF THE DRAWINGS

FIG. 1 illustrates a first embodiment of a container security mechanism.

FIG. 2 illustrates a second embodiment of a container security mechanism.

FIG. 3A depicts a sample pressure versus time plot depicting an embodiment of the invention.

FIG. 3B depicts a sample pressure versus time plot depicting an embodiment of the invention.

FIG. 4 illustrates a flow chart depicting an embodiment of the invention.

FIG. 5 illustrates a flow chart depicting an embodiment of the invention.

### DETAILED DESCRIPTION OF THE PREFERRED EMBODIMENTS

A preferred embodiment of the invention relates to a system and method for securing a container, in transit, through the use of a logging pressure sensor and global navigation receiver unit.

As used herein, the global navigation receiver unit can be associated with various navigation systems, such as Global Navigation Satellite Systems (GNSS) including, for example, Global Positioning System (GPS) or Galileo, to name a few. Preferably, the receiver unit has the ability to log not only position but also time at the logged position of the container. The above systems rely on time of reception of the received signals, and thus are applicable navigation systems for use with the invention. Preferably, the receiver unit minimalizes power usage. Current technologies allow for the usage of such a low power receiver unit to be attached or embedded into the container for use for long time periods (i.e. a shipping cycle or more).

The attachment or embedding of a navigation receiver unit into the container ensures that even if a container is removed from the shipping route, the position of the container at the time of removal or change of course will be known. Thus, the issue of shipped goods being removed when out of range of global wireless reader infrastructure is no longer a concern. Further, the ability to obtain the container in such a situation is highly improved. Thus, the recovery of theft of containers becomes much easier. Also, with regards to a detour in the shipping route due to natural disasters or other unforeseen circumstances, the ability to track the containers with a global navigation receiver unit is highly useful. The containers can be tracked and monitored to ensure on-time delivery and secure transit, even if the pre-set shipping route cannot be utilized.

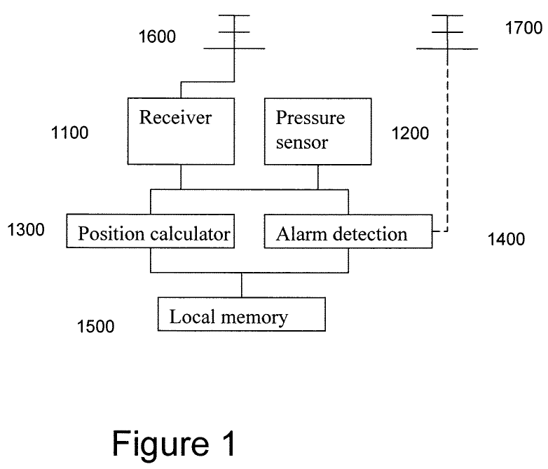

The receiver unit can be coupled with a pressure sensor that is used in tandem to monitor the integrity and position of a container in transit to form a container security mechanism. FIG. 1 shows one embodiment of such a container security mechanism. Data from the receiver 1100 and the pressure sensor 1200 are logged to a local memory device 1500, and can be transmitted to a server or monitoring unit at a remote site (not shown). The navigation receiver unit can calculate and store time and position information 1300 in the local memory device; the pressure sensor can store thresholds for alarm detection 1400 in the local memory device 1500. Preferably, the alarm detection includes a processor (not shown) that can determine whether or not sensor measurements, or changes in sensor measurements, exceed the stored thresholds. The navigation receiver unit is connected to an antenna 1600, and receives signals from the navigation positioning system satellites. The pressure sensor may be connected to an antenna or radio transmitter 1700 that transmits internal pressure information, and optionally navigation information (position and time at position) to a remote location. The security mechanism can also use this antenna 1700 to transmit logged information.

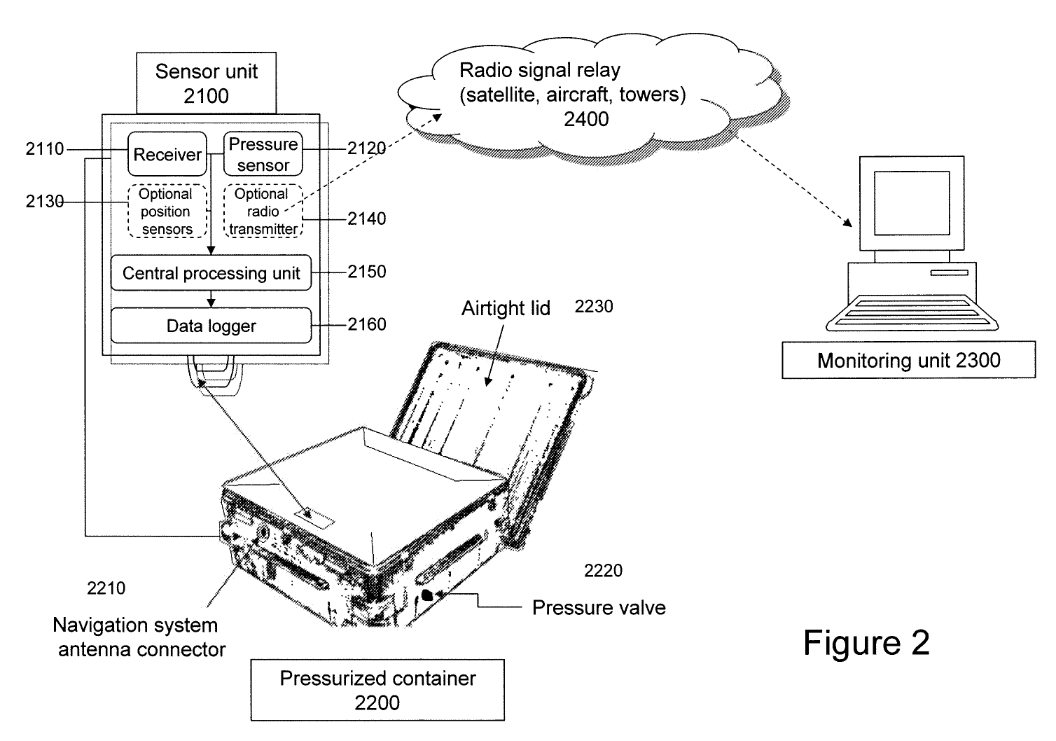

FIG. 2 depicts another embodiment of the container security mechanism. The mechanism contains a sensor unit 2100, a pressurized container 2200, and a monitoring unit 2300. The sensor unit 2100 is contained or placed in the pressurized container 2200, and optionally communicates with the monitoring unit 2300 via a radio signal relay 2400. Specifically, the sensor unit 2100 contains a navigation receiver unit 2110; a pressure sensor 2120; an optional position sensor 2130; an optional radio transmitter 2140 to communicate with the monitoring unit 2300 via a radio signal relay 2400; a central processing unit 2150; and a local memory 2160. The pressurized container 2200 contains a navigation system antenna connector 2210, a pressure valve 2220, an airtight lid 2230, and the sensor unit 2100. The monitoring unit 2300 can be any computer or system known in the art that is able to monitor information transmitted by radio or satellite signals. The optional position sensor 2130 may include Inertial Navigation Units, Dead Reckoning position calculators, or other aiding sensors, to name a few. The optional position sensor 2130 is not limiting on the invention; rather it can be any one of many such sensors known in the art. Further, more than one optional sensor may be utilized with the mechanism.

In one embodiment, the mechanism is embedded into the container, with one or more antennas and/or radio signal relays affixed to the outside of the container to transmit and receive information regarding navigation and sensor measurements. In another embodiment, the mechanism is included into the container with one or more antennas attached, before sealing the container. In a preferred embodiment, the mechanism is activated just before the container is sealed, and is then de-activated only when the container reaches its destination and is lawfully opened. In certain embodiments, the activation and deactivation of the mechanism may only be done by authorized persons who pass security measures. These measures are not limiting on the invention; rather they can be any measures known in the art, such as encryption codes, biometrics, or smart cards.

The container security mechanism verifies the integrity of the container. One method by which the integrity can be verified involves installing the mechanism in an airtight enclosure, which has been artificially pressurized or depressurized before sealing. By placing the mechanism on the inside of the container, variations in pressure inside the container can be detected. Any sudden pressure variation is an intrusion detection; slow variations are due to weather effects (which still apply outside of a partially deformable enclosure), and can be compensated by long-term filtering. Methods of long-term filtering are known in the art; the usage of any of these methods is not limiting on the invention. This detection system can continuously run due to the very low power consumption of current pressure sensors (power consumption is as low as 10 uA).

The internal pressure of the container is preferably periodically detected. Thresholds can be stored in the local memory, or maintained at a remote site, to determine when a variation of internal pressure exceeds a threshold value and indicates intrusion or breach of the container. These thresholds can be set at the time of manufacture, or can be thresholds that are set when the mechanism/container is activated or shipped. If the container is airtight, it can be pressurized, positively or negatively, to increase the ability to detect even small breaches and make it harder to foil the protection. Thus, the thresholds for detection can be more discriminating.

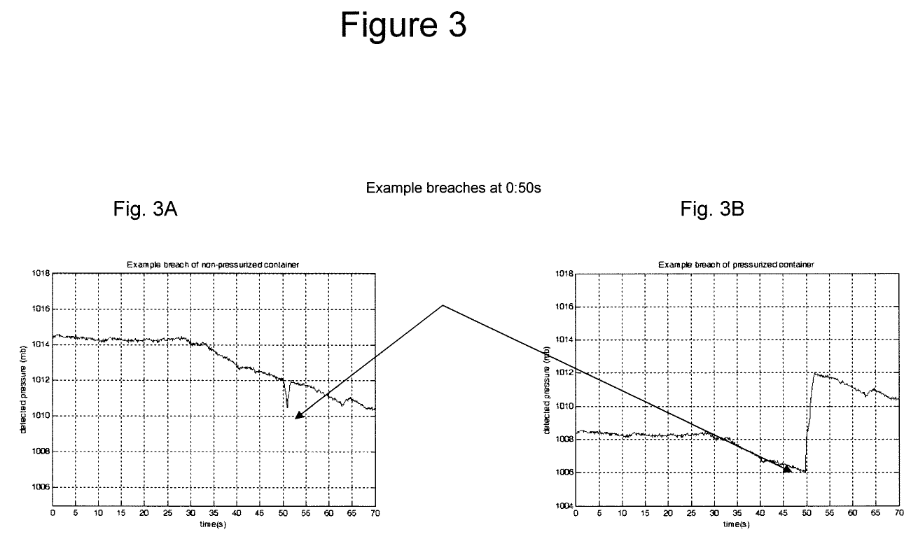

FIGS. 3A and 3B depict sample pressure vs. time plots that detect an intrusion of the container. Even in the presence of weather or altitude changes, the rate-of-change of the barometric pressure when a container is opened is high. The plots of FIGS. 3A and 3B show example barometric sensor responses for opening pressurized and non-pressurized containers. FIG. 3A shows an example breach of a non-pressurized container, where the breach occurs at 50 seconds. FIG. 3B shows an example breach of a pressurized container, where the breach occurs at 50 seconds. The spikes in pressure change due to opening of the container are easily detectable. The plots shown in FIGS. 3A and 3B depict simulated results.

When a variation of internal pressure of the container is detected as an intrusion by the processor, the change in measurement values of the sensor is logged as a breach in the local memory and an alarm is optionally activated. At the same time, the navigation receiver unit optionally logs the position and time of the container at the occurrence of a breach. In one embodiment, at the detection of an intrusion, the pressure sensor sends a signal to a remote site through the antenna. The remote site activates an alarm and takes action to retrieve the container and notify the shippers and vendors as necessary. In another embodiment, the pressure sensor continually sends signals indicating the pressure inside the container via the antenna or radio transmitter to a remote site. When the remote site receives a signal that is outside of a threshold value for pressure variation or detects a change in measurement values that exceeds a threshold, the remote site activates an alarm, notifies the shipper and vendor as necessary, and takes steps to retrieve the container according to the navigation information stored in the local memory of the container.

In one embodiment, the alarm, when activated, acts much like a car alarm, emitting a loud noise at the site of the container. In another embodiment, the alarm acts as a signal to a remote site, indicating breach of the container. In a further embodiment, the alarm emits a noise at the site as well as signals the remote site indicating a breach. These variations on the function of the alarm are in no way limiting to the invention. Other variations as known in the art could be utilized.

Pressure change is utilized to detect an opening of the container (i.e. an intrusion). However, in certain embodiments, the opening of the container may not be detected as an intrusion. Security methods may be coupled with the container security mechanism to detect lawful openings of the container. For example, a unit may be provided to enter a password to open the container. Biometrics or smart keys may also be utilized to gain access to the container. The method of added security for container access is not limiting on the invention; any methods known in the art can be utilized. Thus, if a pressure change outside of the threshold values is detected, along with an authorized security access, such as input of a password, the mechanism will not indicate a breach occurred.

In each of these methods, the breach is logged and optionally transmitted as it occurs, enabling efficient handling of a breach situation. The preferred embodiment provides instantaneous knowledge of a breach of the container in a manner that is very difficult to counter. Because the security mechanism is inside the sealed container, the mechanism cannot be tampered with before the breach of the container. Thus, the intrusion detection by the pressure sensor, and subsequent signalling of an intrusion to a remote site, necessarily occurs before the security mechanism can be accessed, or deactivated.

The local memory is also utilized to handle breach management. In one embodiment, the local memory retains a continual log of the internal pressure and the navigation information (position and time) throughout the shipping process. In another embodiment, the local memory periodically stores pressure and navigation information. In a third embodiment, the local memory only stores pressure information and navigation information at times of breach. Thus, the local memory provides a log by which to verify the integrity of the container and the information regarding a breach of the container, if any such breach did occur. Further, the local memory can provide an auditable log of the transit of the container, and can be utilized to create more efficient or secure shipping methods or routes.

Data in the local memory can be transmitted to a server at a remote site, to be accessed by either the vendor or the shipping company. Thus, tracking of the container, and verification of its integrity, can be continually monitored by a vendor or a shipping company. Further, upon arrival of the container to a pre-determined end location, the vendor or shipping company need only check the log of the position and internal pressure information to ensure that the container is in condition to be sold or utilized. In some embodiments, the log of information is encrypted as it is stored, and decrypted by the vendor or shipper once the container has reached its final destination.

The preferred embodiment provides a valued service to vendors and shippers concerned about the integrity of containers shipped from a start location to an end location. Once the integrity of a container is verified at the start location, as long as a breach is not recorded on the shipping route, the integrity of that container can be assumed to be intact at the end location. Thus, shippers and vendors are able to efficiently ensure that containers have not been tampered with or rendered unusable. In certain embodiments, a tracking application is run on the server at the remote site, allowing shippers and/or vendors to track the position and status of the container, utilizing a tracking number assigned to their specific shipment or container. In one embodiment, the shipper or vendor enters a tracking number and a password into a web-based application to access information about the container. In another embodiment, the shipper or vendor can access information about all of the containers being shipping from a vendor or shipper tracking page.

The size of the container security mechanism is also conducive to shippers and vendors. Because the mechanism is small, and preferably utilizes minimal power, it can be placed in many sizes of containers, from small packages to large shipping crates. The mechanism can be located anywhere on the inside of a container, as long as an antenna connection exists to obtain navigation information and transmit internal pressure information as necessary. Thus, the size of container to be monitored provides no bar to use of the mechanism.

Further, the mechanism can be customizable for each vendor or shipper. The type and frequency of information reported, type of monitoring, and alarm reporting are among the features of the preferred embodiment that can be customized.

In one embodiment, the quality and frequency of reporting could be set by the vendor or shipper. The vendor or shipper could set the period of interval at which navigation and internal pressure information from the mechanism is transmitted to a server at a remote site for access. The vendor or shipper could also set the period of interval at which pressure sensor measurements are taken in the container. The vendor or shipper could also request different amounts of information. For example, the vendor or shipper may request time, position, and/or internal pressure information at each transmission period. The vendor or shipper may instead just request confirmation that a breach has not occurred at each transmission period.

In another embodiment, the vendor or shipper may only monitor navigation information, thus utilizing only the navigation receiver unit and not the pressure sensor in the container security mechanism. Thus, the vendor or shipper may be notified if the container is not on the predetermined shipping route, but will not receive any information as to whether the container has been tampered with or opened.

In a third embodiment, the vendor or shipper may only monitor internal pressure information, thus utilizing only the pressure sensor and not the navigation receiver unit in the container security mechanism. Thus, the vendor shipper may be notified if the container has been tampered with or opened, but will not receive any information as to whether the container is on the correct shipping route, or scheduled to arrive on time with regards to its current position.

In a further embodiment, the vendor or shipper may set the alarm activation such that the vendor or shipper is notified of a breach and handles breach management. Otherwise, the vendor or shipper may rely on a third party to handle breach management, and may set the alarm such that the third party is notified of the breach as well. The vendor or shipper may also set the alarm to notify local authorities in the vicinity of the breach by utilizing the navigation information logged when the breach occurred.

In another embodiment, different types of sensors, or more than one sensor, can be utilized as part of the container security mechanism. Examples of such sensors include, but are not limited to, accelerometers, temperature sensors, and other position tracking sensors such as Inertial Navigation Units, Dead Reckoning position calculators, or other aiding sensors, to name a few. In a preferred embodiment, a sensor such as the SMD-500 manufactured BOSCH™ Sensortec is utilized with a Nemerix™ navigation receiver unit.

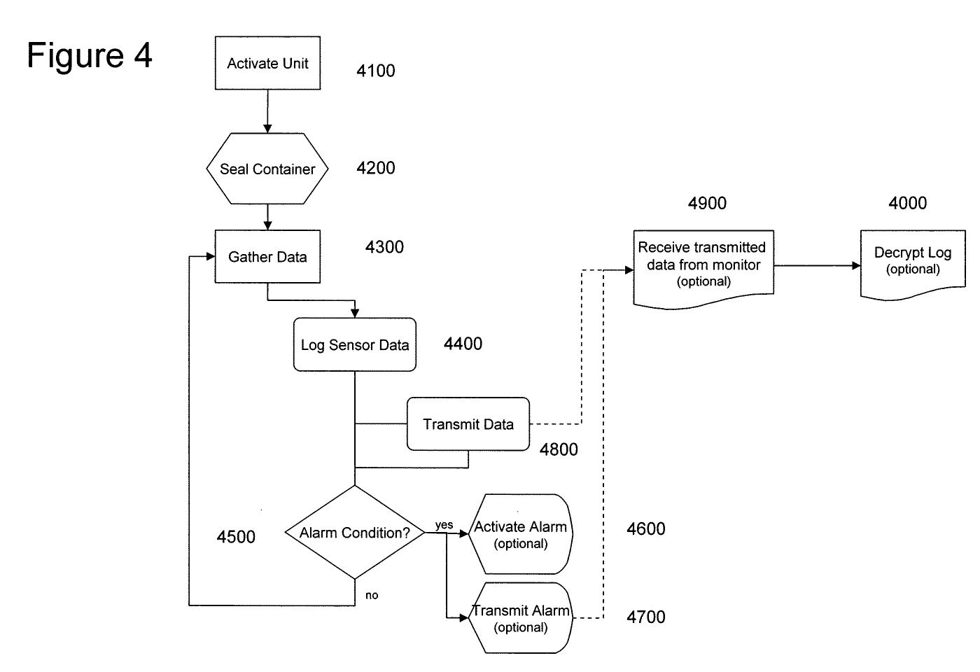

FIG. 4 depicts a flow chart of a preferred embodiment where the mechanism is activated and the container is shipped. In step 4100, the unit is activated. Step 4200 involves sealing the container. In step 4300, the unit gathers data from either the navigation receiver unit, the sensor, or both. In step 4400, the gathered data is logged. In one embodiment, the data is analyzed, and it is determined if a breach occurred and an alarm should be activated (step 4500). In this embodiment, the alarm may then be activated (step 4600), or it may be transmitted to a remote site (step 4700). In another embodiment, the additional step of transmitting the data to the remote site (step 4800) occurs after step 4400. Data is then analyzed to determine if a breach occurred and an alarm should be activated (step 4500). If a breach is found, several options exist. In one embodiment, the alarm is activated (step 4600).

In another embodiment, the alarm is transmitted to the remote site (step 4700). If this second branch is followed, regardless of whether step 4800 occurs, the alarm and/or gathered data is received at the remote site (step 4900). If the gathered data was encrypted, then the data is decrypted at step 4000.

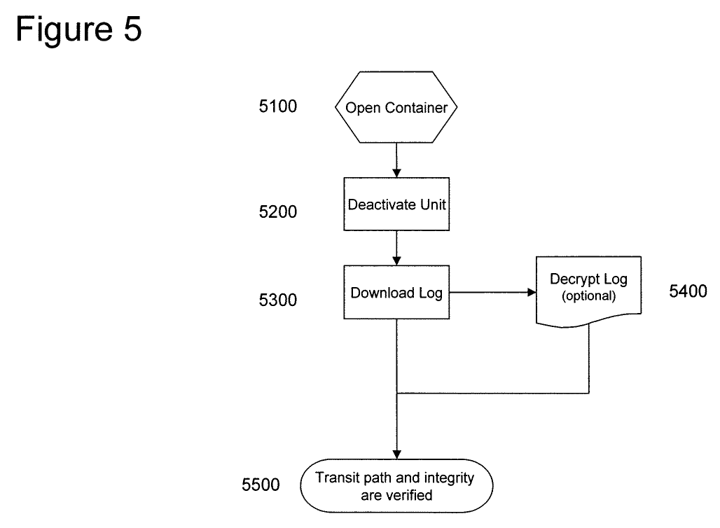

FIG. 5 depicts the flow of an embodiment where the container arrives at the destination. In step 5100, the container is opened. The unit is then deactivated (step 5200). The log is downloaded at step 5300, and then optionally decrypted at step 5400. Finally, the transit path and integrity of the container's contents are verified (step 5500). This verification occurs by checking the log for any abnormalities. An abnormality would be any change in sensor measurement values outside a pre-set range or threshold. The contents of the container can be verified if no such abnormalities exist. If there are any abnormalities, that is an indication that the container was breached in transit.

In another application, certain embodiments could be utilized for verifying the recorded data of a navigation receiver unit. Specifically, a pressure sensor could be used inside a container containing only a navigation receiver unit. The processor would analyze the sensor measurements, such that changes in measurement values of the sensor that exceed a threshold would indicate a breach of the container. In one embodiment, the local memory would only log any such indicative changes. Thus, if there were any logged changes, the data recorded from the navigation receiver unit would not be verified. However, if no such changes were logged, then the data from the navigation receiver unit could be verified as authentic. In another embodiment, the local memory would log all of the sensor measurements, and the log would be an auditable record of the sensor values. A third party, such as a vendor or shipper, would then be able to view the log and see if there were any changes in measurement values that exceeded a threshold, thus indicating a breach of the container.

Certain embodiments can also be utilized in other security applications, specifically those relating to shipping. For example, the container security mechanism could be utilized with military shipping equipment. In another embodiment, the container security mechanism can be placed on the inside of HAZMAT (hazardous materials) trucks used in shipping, such that the opening of the cargo doors triggers an alarm if necessary. The security mechanism can also be utilized for other cargo shipping, such as money transport. The container security mechanism could replace existing armored trucks, making the shipment of valuable goods such as money or gold much more easily trackable and tamper-resistant.

In another application, certain embodiments could be utilized for inventory management, especially with regards to perishable items. In this embodiment, a sensor other than a pressure sensor could be utilized, to best suit the inventory being monitored. Thus, both or one of pressure and temperature sensors could be coupled to the navigation receiver unit. For example, the container security mechanism could be placed inside freezers containing meats or fish, that are transported from a warehouse to a grocery store. Those freezers in which pressure changed due to the opening of lid, or in which temperature changed past a predetermined threshold, would be inspected to insure quality of food products. Thus, tainted or spoiled food would not be introduced into the store for sale. Further, food inspection becomes much more efficient, because inventory managers need only inspect those boxes or containers in which a breach has occurred.

Another embodiment relates again to transporting goods, specifically organs and other body parts. Because of the thriving black market of organ sales and the purpose for their transport, the secure and efficient transfer of these goods must be guaranteed. These goods require the maintenance of specific conditions inside the containers in which they are transported. This embodiment may also utilize a sensor other than a pressure sensor.

What is claimed is:

1. A container security device, comprising:
a sensor; and
a local memory configured to store input from the sensor;
wherein the device is configured to detect a breach of a container.

2. A device as claimed in claim 1, further comprising a processor that is configured to detect a breach of the container when a change in measurement values from the sensor exceeds a threshold.

3. A device as claimed in claim 2, wherein the change in measurement values is stored in the local memory when the breach occurs.

4. A device as claimed in claim 2, further comprising a navigation receiver unit, wherein the local memory is configured to store input from the navigation receiver unit.

5. A device as claimed in claim 4, wherein, when a breach occurs, information regarding the time the breach occurred is stored in the local memory.

6. A device as claimed in claim 2, further comprising an alarm, wherein the alarm is configured to activate when a breach occurs.

7. A device as claimed in claim 1, wherein a change in measurement values from the sensor is sent to a remote site to determine if it exceeds a threshold.

8. A device as claimed in claim 7, wherein the remote site is configured to activate an alarm.

9. A device as claimed in claim 2, wherein a change in measurement values that exceeds a threshold is not detected as a breach if an authorized security access is made at the time of the change in measurement values.

10. A device as claimed in claim 1, wherein the sensor is a pressure sensor.

11. A device as claimed in claim 10, wherein the container is sealed such that pressure inside the container is not atmospheric pressure.

12. A device as claimed in claim 1, further comprising:
at least one more sensor.

13. A method of securing a container, comprising the steps of:
detecting a change in a measurement values inside a container; and
indicating a breach if the change in measurement values exceeds a threshold.

14. A method as claimed in claim 13, wherein the step of indicating a breach comprises storing the change in measurement values in a local memory.

15. A method as claimed in claim 13, further comprising the step of:
detecting time and position information of the container.

16. A method as claimed in claim 15, wherein the step of indicating a breach comprises storing information about the position of the container at the time of the breach, and the time of the breach, in a local memory.

17. A method as claimed in claim 13, wherein the step of indicating a breach comprises activating an alarm.

18. A method as claimed in claim 13, further comprising the step of:
sending the change in measurement values to a remote site to determine if it exceeds a threshold.

19. A method as claimed in claim 13, wherein the change in measurement values that exceeds a threshold is not detected as a breach if an authorized security access is made at the time of the change in measurement values.

20. A method as claimed in claim 13, wherein the sensor is a pressure sensor.

21. A device as claimed in claim 20, further comprising the step of:
sealing the container such that pressure inside the container is not atmospheric pressure.

22. A method of determining if a container was breached, comprising the steps of:
downloading a log of gathered information; and
checking the gathered information for any abnormalities;
wherein an abnormality is a change in measurement values taken from a sensor inside a container that exceeds a threshold.

23. The method of claim 22, wherein the measurement values are obtained from a pressure sensor.

24. The method of claim 22, wherein the gathered information was encrypted.

25. The method of claim 24, further comprising the step of:
decrypting the gathered information.

26. A device for maintaining security of a navigation receiver unit, comprising:
an enclosure, comprising:
a sensor;
a processor;
a local memory configured to store input from the sensor; and
a navigation receiver unit;
wherein the device is configured to detect a breach of the enclosure.

27. A device as claimed in claim 26, wherein the processor is configured to detect a breach of the enclosure when a change in measurement values from the sensor exceeds a threshold.

28. A device as claimed in claim 27, wherein the local memory stores the change in measurement values from the sensor.

29. A device as claimed in claim 26, wherein the sensor is a pressure sensor.

30. A device as claimed in claim 29, wherein the enclosure is sealed such that pressure inside the enclosure is not atmospheric pressure.
